(19) United States
(12) Patent Application Publication
(10) Pub. No.: US 2023/0132881 A1
(43) Pub. Date: May 4, 2023

(54) METHODS, APPARATUS, STORAGE MEDIUMS, AND ELECTRONIC DEVICES FOR IMFORMATION EXCHANGE

(71) Applicant: BEIJING DIDI INFINITY TECHNOLOGY AND DEVELOPMENT CO., LTD., Beijing (CN)

(72) Inventor: Xudong ZHANG, Beijing (CN)

(73) Assignee: BEIJING DIDI INFINITY TECHNOLOGY AND DEVELOPMENT CO., LTD., Beijing (CN)

(21) Appl. No.: 18/147,011

(22) Filed: Dec. 28, 2022

Related U.S. Application Data
(63) Continuation of application No. PCT/CN2021/110206, filed on Aug. 3, 2021.

(30) Foreign Application Priority Data
Aug. 11, 2020 (CN) 202010803509.5

(51) Int. Cl. G01C 21/34; G01C 21/00; G06Q 50/30

(52) U.S. Cl. CPC G01C 21/3415; G01C 21/3856; G06Q 50/30

(57) ABSTRACT

The embodiments of the present disclosure provide a method, an apparatus, a storage medium, and an electronic device for information exchange. After receiving task information of a task, a task processing terminal may send its own position. A task issuing terminal may control a display device to render and display a position modification control corresponding to the task. In response to the position modification control is triggered, the task issuing terminal may display a modification page to detect a input operation. In response to that the input operation is detected, the task issuing terminal may determine corresponding position information and send position modification information determined based on the position information to a server. The server may obtain the task information and send, in response to that a task processing state of the task is unprocessed, a position modification prompt and the position modification information, so that the task processing terminal may modify a starting position of the task based on the position information. The method in the embodiments of the present disclosure may reduce a possibility of a task being cancelled and improve a utilization rate of task processing resources.

### CROSS-REFERENCE TO RELATED DISCLOSURES

This application is a Continuation of International Application No. PCT/CN2021/110206, filed on Aug. 3, 2021, which claims priority to Chinese Patent Application No. 202010803509.5, filed on Aug. 11, 2020, the contents of each of which are incorporated herein by reference.

### TECHNICAL FIELD

The present disclosure generally relates to the field of computer technology, and in particular to, methods, apparatus, storage mediums, and electronic devices for information exchange.

### BACKGROUND

With the continuous development of the computer technology field and the internet technology field, more and more users choose to formulate ride plans and issue car-hailing demands on an online car-hailing platform. The online car-hailing platform brings great convenience to users' travel, but sometimes users need to change their car-hailing demands, especially pick-up positions. The prior art generally cannot meet the users' requirement for changing the pick-up positions, which may cause the users to cancel the ride plans, thereby causing unnecessary waste of task processing resources.

### SUMMARY

The embodiments of the present disclosure provide a method, an apparatus, a storage medium, and an electronic device for information exchange to improve a utilization rate of task processing resources.

A first aspect of the embodiments of the present disclosure provides a method for information exchange, applied to a task processing terminal.

The method may include sending, in response to receiving task information of a task, first position information. The first position information may be configured to indicate a current position of the task processing terminal. The task information may include second position information. The second position information may be configured to indicate a starting position of the task.

The method may include receiving a position modification prompt and position modification information. The position modification information may include third position information.

The method may further include modifying the starting position of the task based on the third position information.

A second aspect of the embodiments of the present disclosure provides a method for information exchange.

The method may include receiving position modification information sent by a task issuing terminal. The position modification information may include third position information.

The method may include obtaining task information of a task. The task information may include second position information. The second position information may be configured to indicate a starting position of the task.

The method may include sending, in response to that a task processing state of the task is unprocessed, a position modification prompt and the position modification information. The position modification prompt may be configured to instruct the task processing terminal to modify the starting position based on the third position information. The task processing state may be determined based on first position information. The first position information may be configured to indicate a current position of the task processing terminal.

A third aspect of the embodiments of the present disclosure provides a method for information exchange, applied to a task issuing terminal.

The method may include controlling a display device to render and display a position modification control corresponding to a task.

The method may include displaying, in response to that the position modification control is triggered, a modification page.

The method may include detecting an input operation.

The method may include in response to that a first input operation is detected, determining third position information. The third position information may be position information corresponding to the first input operation.

The method may include determining position modification information based on the third position information.

The method may include sending the position modification information to a server to modify a starting position of the task.

A fourth aspect of the embodiments of the present disclosure provides an apparatus for information exchange, applied to a task processing terminal.

The apparatus may include a position sending unit configured to send, in response to receiving task information of a task, first position information. The first position information may be configured to indicate a current position of the task processing terminal. The task information may include second position information. The second position information may be configured to indicate a starting position of the task.

The apparatus may include a first information receiving unit configured to receive a position modification prompt and position modification information. The position modification information may include third position information.

The apparatus may include a first position modification unit configured to modify the starting position of the task based on the third position information.

A fifth aspect of the embodiments of the present disclosure provides an apparatus for information exchange.

The apparatus may include a second information receiving unit configured to receive position modification information sent by a task issuing terminal. The position modification information may include third position information.

The apparatus may include a first information acquisition unit configured to obtain task information of a task. The task information may include second position information. The second position information may be configured to indicate a starting position of the task.

The apparatus may include a second prompt unit configured to send, in response to that a task processing state of the task is unprocessed, a position modification prompt and the position modification information to a task processing terminal. The position modification prompt may be configured to instruct the task processing terminal to modify the starting position based on the third position information. The task processing state may be determined based on first position information. The first position information may be configured to indicate a current position of the task processing terminal.

A sixth aspect of the embodiments of the present disclosure provides an apparatus for information exchange, applied to a task issuing terminal.

The apparatus may include a control rendering unit configured to control a display device to render and display a position modification control corresponding to a task.

The apparatus may include a page display unit configured to display, in response to that the position modification control is triggered, a modification page.

The apparatus may include an input detection unit configured to detect an input operation.

The apparatus may include a position determination unit configured to determine, in response to that a first input operation is detected, third position information. The third position information may be position information corresponding to the first input operation.

The apparatus may include an information determination unit configured to determine position modification information based on the third position information.

The apparatus may include an information sending unit configured to send the position modification information to a server to modify a starting position of the task.

A seventh aspect of the embodiments of the present disclosure provides a method for information exchange.

The method may include sending, in response to receiving task information of a task, first position information. The first position information may be configured to indicate a current position of a task processing terminal. The task information may include second position information. The second position information may be configured to indicate a starting position of the task.

The method may include controlling a display device to render and display a position modification control corresponding to the task.

The method may include displaying, in response to that the position modification control is triggered, a modification page

The method may include detecting an input operation.

The method may include determining, in response to that a first input operation is detected, third position information. The third position information may be position information corresponding to the first input operation.

The method may include determining position modification information based on the third position information.

The method may include sending the position modification information to modify the starting position.

The method may include receiving the position modification information.

The method may include obtaining the task information of the task.

The method may include sending, in response to that a task processing state of the task is unprocessed, a position modification prompt and the position modification information. The position modification prompt may be configured to instruct the task processing terminal to modify the starting position based on the third position information. The task processing state may be determined based on the first position information.

The method may include receiving the position modification prompt and the position modification information.

The method may include modifying the starting position of the task based on the third position information.

An eighth aspect of the embodiments of the present disclosure provides a system for information exchange.

The system may include a position sending unit configured to send, in response to receiving task information of a task, first position information. The first position information may be configured to indicate a current position of a task processing terminal. The task information may include second position information. The second position information may be configured to indicate a starting position of the task.

The system may include a control rendering unit configured to control a display device to render and display a position modification control corresponding to the task.

The system may include a page display unit configured to display, in response to that the position modification control is triggered, a modification page.

The system may include an input detection unit configured to detect an input operation.

The system may include a position determination unit configured to determine, in response to that a first input operation is detected, third position information. The third position information may be position information corresponding to the first input operation.

The system may include an information determination unit configured to determine position modification information based on the third position information.

The system may include an information sending unit configured to send the position modification information to a server to modify the starting position.

The system may include a second information receiving unit configured to receive the position modification information.

The system may include a first information acquisition unit configured to obtain task information of a task. The task information may include second position information.

The system may include a second prompt unit configured to send, in response to that a task processing state of the task is unprocessed, a position modification prompt and the position modification information to the task processing terminal. The position modification prompt may be configured to instruct the task processing terminal to modify the starting position based on the third position information. The task processing state may be determined based on the first position information.

The system may include a first information receiving unit, configured to receive the position modification prompt and the position modification information.

The system may include a first position modification unit, configured to modify the starting position of the task based on the third position information.

A ninth aspect of the embodiments of the present disclosure provides a computer-readable storage medium storing a set of computer program instructions that, when executed by at least one processor, direct the at least one processor to perform the method of any one of the first or seventh aspect.

A tenth aspect of the embodiments of the present disclosure provides an electronic device including a memory and a processor. The memory may be configured to store one or more computer program instructions that, when executed by the processor, direct the processor to perform the method of any one of the first or seventh aspect.

After receiving task information of a task, a task processing terminal may send its own position. A task issuing terminal may control a display device to render and display a position modification control corresponding to the task. In response to the position modification control is triggered, the task issuing terminal may display a modification page to detect a input operation. In response to that the input operation is detected, the task issuing terminal may determine corresponding position information and send position modification information determined based on the position information to a server. The server may obtain the task information and send, in response to that a task processing state of the task is unprocessed, a position modification prompt and the position modification information, so that the task processing terminal may modify a starting position of the task based on the position information. The method in the embodiments of the present disclosure may reduce a possibility of a task being cancelled and improve a utilization rate of task processing resources.

### BRIEF DESCRIPTION OF THE DRAWINGS

The above-mentioned and other purposes, features, and advantages of the present disclosure would become more apparent by the following description of the embodiments of the present disclosure with reference to the accompanying drawings, in which:

FIG. 1 is a schematic diagram illustrating an exemplary hardware system according to some embodiments of the present disclosure;

FIG. 2 is a flowchart illustrating an exemplary process for information exchange according to first embodiments of the present disclosure;

FIG. 3 is a schematic diagram illustrating an exemplary page according to first embodiments of the present disclosure;

FIG. 4 is a schematic diagram illustrating an exemplary map page according to first embodiments of the present disclosure;

FIG. 5 is a schematic diagram illustrating an exemplary map page according to first embodiments of the present disclosure;

FIG. 6 is a schematic diagram illustrating an exemplary map page according to first embodiments of the present disclosure;

FIG. 7 is a schematic diagram illustrating exemplary map pages according to first embodiments of the present disclosure;

FIG. 8 is a flowchart illustrating an exemplary process for information exchange applied to a task processing terminal in an optional implementation of first embodiments of the present disclosure;

FIG. 9 is a flowchart illustrating an exemplary process for information exchange applied to a server in an optional implementation of first embodiments of the present disclosure;

FIG. 10 is a flowchart illustrating an exemplary process for information exchange applied to a task issuing terminal in an optional implementation of first embodiments of the present disclosure;

FIG. 11 is a flowchart illustrating an exemplary process for information exchange according to second embodiments of the present disclosure;

FIG. 12 is a flowchart illustrating an exemplary process for information exchange applied to a task processing terminal in an optional implementation of second embodiments of the present disclosure;

FIG. 13 is a flowchart illustrating an exemplary process for information exchange applied to a server in an optional implementation of second embodiments of the present disclosure;

FIG. 14 is a flowchart illustrating an exemplary process for information exchange applied to a task issuing terminal in an optional implementation of second embodiments of the present disclosure;

FIG. 15 is a flowchart illustrating an exemplary system for information exchange according to third embodiments of the present disclosure; and

FIG. 16 is a schematic diagram illustrating an exemplary electronic device according to fourth embodiments of the present disclosure.

### DETAILED DESCRIPTION

The present disclosure is described below based on embodiments, but the present disclosure is not limited to these embodiments. In the detailed description of the present disclosure below, specific portions of the details are described in detail. The present disclosure may be fully understood by those skilled in the art without the description of these detailed portions. To avoid confusion as to the substance of the present disclosure, the well-known methods, processes, procedures, components, and circuits are not described in detail.

In addition, it should be understood by those of ordinary skill in the art that the accompanying drawings are provided herein for illustrative purposes and that the accompanying drawings are not necessarily to scale.

Unless the context clearly requires otherwise, the words “includes,” “contains,” and similar words in the present disclosure should be interpreted to mean inclusive rather than exclusive or exhaustive, that is, to mean “including but not limited to”.

In the description of the present disclosure, it is to be understood that the terms “first,” “second,” etc. are used for descriptive purposes only and are not to be construed as indicating or implying relative importance. In addition, in the description of the present disclosure, “plurality” means two or more unless otherwise specified.

In the embodiments of the present disclosure, take the task as a car-hailing order as an example to illustrate. However, it is readily understood by those skilled in the art that the method of the embodiments of the present disclosure is equally applicable when the task t is another type of task, such as a logistics delivery task.

In car-hailing modes such as carpooling, express car, and ride-hailing, users sometimes need to change their car-hailing demands, especially a pick-up position. For example, a user C1 agrees to take a ride at a position A at 10:00 a.m., but at 9:50 a.m. the user C1 handles some business at a position B. There is a certain distance between the position A and the position B. so that the user C1 cannot arrive at the position A at 10:00 a.m., accordingly, the user C1 needs to change the pick-up position to position B. In the prior art, if the user C1 has confirmed the car-hailing order for boarding at 10:00 a.m. (that is, a task has been generated), the pick-up position in the car-hailing order cannot be modified, therefore, the user C1's requirement for changing the pick-up position cannot be satisfied. As a result, the user C1 may cancel the car-hailing order. At this time, a driver D1 (that is, a task processing resource corresponding to the task) is likely to be close to or has arrived at the position A. In such cases, the driver D1 can only receive a new car-hailing order, and before the appointed time of the new car-hailing order, the driver D1 can only continue to wait, which causes unnecessary waste of the task processing time of the driver D1.

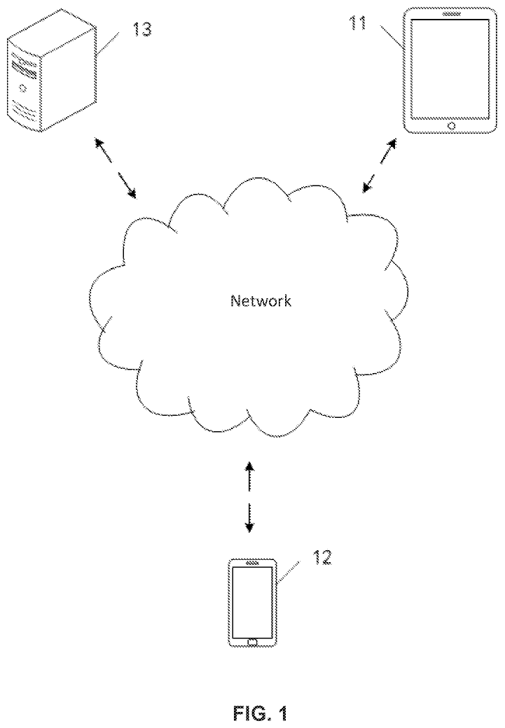

FIG. 1 is a schematic diagram illustrating an exemplary hardware system according to some embodiments of the present disclosure. As shown in FIG. 1, the hardware system may include a plurality of task issuing terminals, a plurality of task processing terminals, and at least one server. For illustration purposes, FIG. 1 take one task issuing terminal 11, one task processing terminal 12, and one server 13 as examples for description. The task issuing terminal 11, the task processing terminal 12, and the server 13 shown in FIG. 1 may be communicatively connected via a network. In the embodiments of the present disclosure, the task issuing terminal 11 may be a user terminal. A user may issue a car-hailing demand through a car-hailing order on an online car-hailing platform through the task issuing terminal 11. After obtaining the car-hailing order from the online car-hailing platform, the server 13 may assign the car-hailing order to the task processing terminal 12, so that a task processing resource that holds the task processing terminal 12 may provide the user with a car-hailing service according to an appointed time of the car-hailing order.

In the embodiments of the present disclosure, after receiving task information of the task, the task processing terminal 12 may send first position information configured to indicate a current position of the task processing terminal 12. The task issuing terminal 11 may control a display device to render a position modification control corresponding to the task. If the position modification control is triggered, the task issuing terminal 11 may display a modification page and detect an input operation. When a first input operation is detected, the task issuing terminal 11 may determine third position information corresponding to the first input operation and determine position modification information based on the third position information, thereby sending the position modification information to the server 13 to modify a starting position of the task. The server 13 may receive the position modification information and obtain task information of the task. If a task processing state of the task is unprocessed (that is, the user has not taken a ride), the server 13 may send a position modification prompt and the task modification information to the task processing terminal 12 to instruct the task processing terminal 12 to modify the starting position of the task based on the third position information.

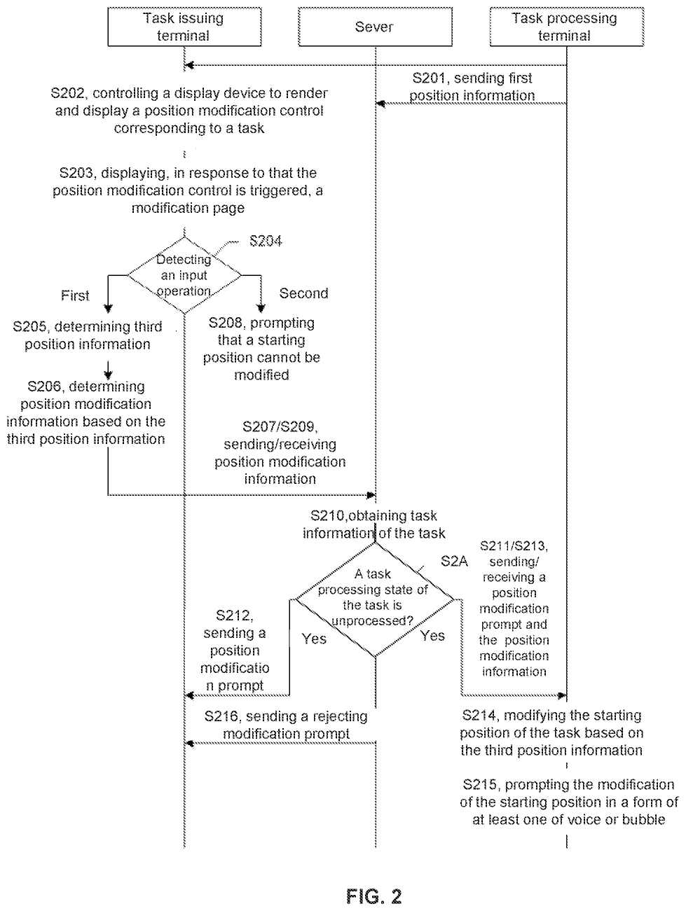

FIG. 2 is a flowchart illustrating an exemplary process for information exchange according to first embodiments of the present disclosure. As shown in FIG. 2, the process in the embodiments may include the following operations.

In S201, in response to receiving task information of a task, first position information may be sent.

Before operation S201, a task issuing terminal may determine the task information of the task based on an appointed time set by a user, second position information, a task identifier, etc., and issue the task to an online car-hailing platform. The second position information may be the starting position of the task. After receiving the task through the online car-hailing platform, the server may assign the task to the task processing terminal through various existing manners, and send the task information of the task to the task processing terminal. After receiving the task information of the task, the task processing terminal may upload the first position information used to indicate the current position of the task processing terminal.

In S202, a display device may be controlled to render and display a position modification control corresponding to the task.

In the embodiments, the task issuing terminal may obtain the first position information, and control, in response to that a distance between the first position information and the second position information satisfies a distance condition and the second position information satisfies at least one of position conditions, the display device to render and display the position modification control corresponding to the task on a map page based on the second position information, so that the user may modify the starting position of the task by triggering the position modification control, which improves the flexibility of the modification of the starting position and reduces the possibility of the tasks being cancelled, thereby reducing unnecessary waste of task processing resources.

For example, a first position information of a task processing resource is a position L1. A starting position (that is, a second position information) set by the user is L2. If a distance between the position L1 and the position L2 is greater than 1000 m (that is, a distance condition is satisfied), and/or the position L2 is in a range (For example, a range other than an airport, a railway station, etc. with a spatial structure complexity greater than or equal to the first threshold) with a spatial structure complexity less than a first threshold (that is, a position condition is satisfied), the task issuing terminal may control the display device to render and display the position modification control corresponding to the task on the map page based on the second position information.

The spatial structure complexity may be determined in various existing ways. For example, the spatial structure complexity may be determined based on a pre-marked category label (e.g., the category labels of railway stations, subway stations, etc.), or determined based on information in each area within a target position range such as a flow of people, the number of floors, the number of buildings, etc., which is not limited in the embodiments.

For example, in an area 1 within a target position range, the flow of people is 1000 people/hour, the number of floors (specifically an average number of floors) is 8, the number of buildings is 5, and weights corresponding to the flow of people, the number of floors, and the number of buildings are 0.3, 0.3, and 0.4, the spatial structure complexity of the area 1 may be determined as 304.4.

Additionally or alternatively, the task issuing terminal may render and display the position modification control at a predetermined position on the map page, or render and display the position modification control at a position corresponding to the second position information on the map page, which is not limited in the embodiments. Generally, the second position information is located near a center of the map page, accordingly the predetermined position may be located at an upper left corner, a lower left corner, an upper right corner, a lower right corner, etc. on the map page.

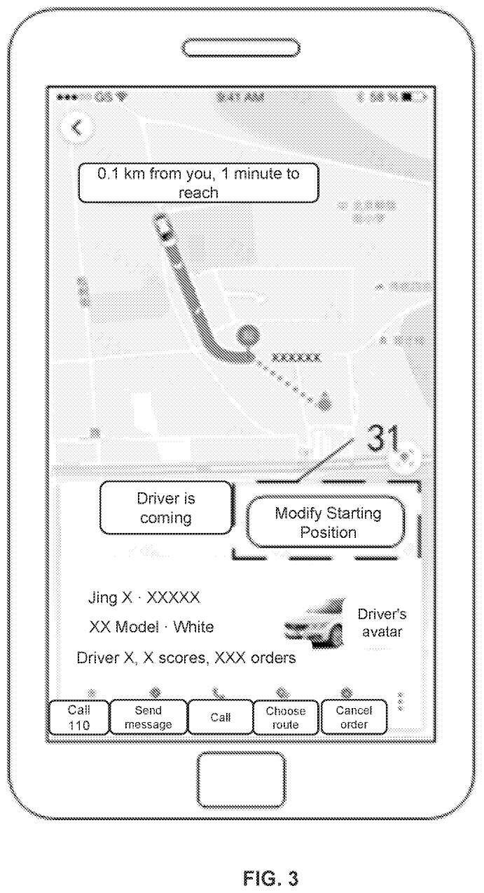

FIG. 3 is a schematic diagram illustrating an exemplary map page according to first embodiments of the present disclosure. As shown in FIG. 3, if the distance between the first position information and the second position information satisfies the distance condition and/or the second position information satisfies the position condition, the task issuing terminal may control the display device to render and display the position modification control at a position 31 on the map page, that is a control represented as “Modify Starting Position” on the map page.

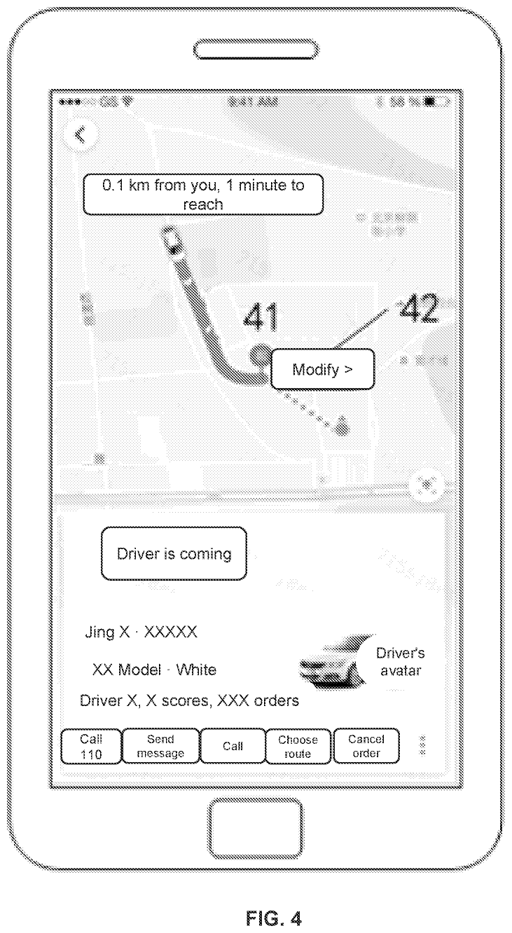

FIG. 4 is a schematic diagram illustrating an exemplary map page according to first embodiments of the present disclosure. As shown in FIG. 4, if the distance between the first position information and the second position information satisfies the distance condition and/or the second position information satisfies the position condition, the task issuing terminal may control the display device to render and display the position modification control at a position on the map page corresponding to an icon 41 (that is, the second position information), that is a control represented as “Modify >” on the map page.

In S203, in response to that the position modification control is triggered, a modification page may be displayed.

In response to that the position modification control is triggered, the task issuing terminal may display the modification page. In the embodiments, the modification page may be the map page. In operation S203, the task issuing terminal may display a target position range where the second position information is located on the modification page, so that the user may select any one position in the target position range to modify the starting position of the task, thereby avoiding the possibility that the task processing resource cannot arrived at the starting position modified by the user at the appointed time, thus causing a greater impact on the completion of the task. Additionally or alternatively, the task issuing terminal may display the target position range and non-target position ranges in different colors, or only display the target position range. For example, the color of the target position range may be displayed as colored, and the color outside the target position range may be displayed as gray.

Additionally or alternatively, the task issuing terminal may control the display device to render and display a position confirmation control on the modification page, and determine, in response to that the position confirmation control is triggered, a position corresponding to the most recent first input operation as a third position information.

Additionally or alternatively, the task issuing terminal may obtain at least one recommended modification position in the target position range, store position information of the at least one recommended modification position, and simultaneously display the position information on the modification page to prompt the user during a modification process of the starting position. The recommended modification position may be position information in historical data whose number or proportion set as a starting position by multiple users is higher than a second threshold.

It is easy to understand that the task issuing terminal may display the target position range and control the display device to render and display the position confirmation control, or only display the target position range, or only control the display device to render and display the position confirmation control, which is not limited in the embodiments.

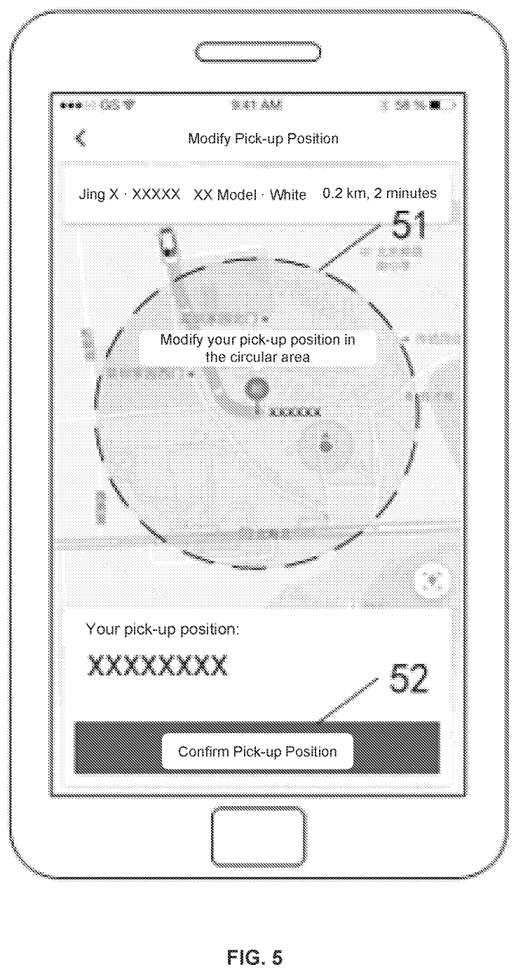

FIG. 5 is a schematic diagram illustrating an exemplary map page according to first embodiments of the present disclosure. With reference to FIG. 3 or FIG. 4, as shown in FIG. 5, in response to that the control represented as “Modify Starting Position” in FIG. 3 or the control represented as “Modify >” in FIG. 4 is triggered, the task issuing terminal may display the modification page, that is, a page represented as “Modify Pick-up Position,” and display, on the modification page, the target position range (that is, a circular area 51 shown in FIG. 5) corresponding to the second position information and the position confirmation control (that is, a control 52 represented as “Confirm Pick-up Position.” It is easy to understand that the circular area 51 is only a representation of the target position range, and the target position range may be in other shapes, such as a rectangle shape, an irregular shape, etc., which is not limited in the embodiments.

In S204, an input operation may be detected.

After the modification page is displayed, the task issuing terminal may detect the input operation of the user to determine third position information. If the detected input operation is a first input operation, the task issuing terminal may perform operation S205. Additionally or alternatively, if the detected input operation is a second input operation, the task issuing terminal may perform operation S208.

In S205, the third position information may be determined.

In operation S205, the task issuing terminal may obtain, in response to detecting the first input operation, position information corresponding to the first input operation and determine, in response to that the position confirmation control is triggered, the position information as the third position information. The first input operation may be an operation for the user to select a position within the target position range, and may specifically be a click operation, a drag operation, or the like, which is not limited in the embodiments. Additionally or alternatively, the task issuing terminal may further display the position information corresponding to the first input operation on the modification page.

Specifically, in possible cases, the target position range may include at least one recommended modification position. If the user clicks any one of the at least one recommended modification position, the task processing terminal may detect the first input operation, and directly display position information corresponding to the recommended modification position. In possible cases, the target position range may include a region whose spatial structure complexity is higher than the first threshold. If the user selects, by dragging and dropping, any one position other than the region in the target position range, the task issuing terminal may detect the first input operation and request a position service to obtain position information corresponding to the first input operation to display the obtained position information. In possible cases, the position confirmation control may be rendered and displayed on the modification page, and the input operation of the user may satisfy a triggering condition of the first input operation (that is, the user selects any one modification position within the target position range, or select any one position in a region whose spatial structure complexity is not higher than the first threshold in the target position range), and then the task issuing terminal may render a click state of the position confirmation control into a clickable state and determine, in response to that the position confirmation control is triggered, the position information corresponding to the most recent first input operation as the third position information.

Taking a page shown in FIG. 5 as an example for description, the modification page may include a circular area 51 and a control 52 (that is, a position confirmation control) represented as “Confirm Pick-up Position.” The circular area 51 may include at least one recommended modification position and a railway station. If the user selects any recommended modification position in the circular area 51 or any position in the circular area 51 that is not a railway station and a recommended modification position, the task issuing terminal may detect the first input operation and obtain the position information corresponding to the first input operation to display the obtained position information. The obtained position information may be specifically displayed as XX road, XX community, etc. At the same time, the click state of the control 52 represented as “Confirm Pick-up Position” may be rendered as a clickable state. If the control 52 represented as “Confirm Pick-up Position” is triggered, the task issuing terminal may determine the position information corresponding to the most recent first input operation as the third position information.

In S206, the position modification information may be determined based on the third position information.

After determining the third position information, the task issuing terminal may determine the position modification information based on the third position information. Additionally or alternatively, the position modification information may include a task identifier, a user identifier, etc. of the task, which is not limited in the embodiments.

In S207, the position modification information may be sent.

In operation S207, the task issuing terminal may send the position modification information to the server to modify the starting position of the task.

In S208, unable to modify the starting position may be prompted.

Additionally or alternatively, in the embodiments, if the second input operation is detects, the task issuing terminal may prompt the user that the starting position cannot be modified by a form of at least one of voice or bubble. The second input operation may be a user's position selection operation in a non-target position range or a region with a spatial structure complexity higher than the first threshold within the target position range. The second input operation may include a click operation, a drag operation, etc., which is not limited in the embodiments.

In possible cases, if the user selects, by dragging and dropping, any one position outside the target position range, the task issuing terminal may detect the second input operation and prompt that the starting position of the task cannot be modified. In possible cases, the target position range may include a region with a spatial structure complexity higher than the first threshold. If the user selects any one position within the target position range by dragging, the task issuing terminal may detect the second input operation and prompt that the starting position of the task cannot be modified. In possible cases, the position confirmation control may be rendered and displayed on the modification page, and the input operation of the user may satisfy a triggering condition of the first input operation (that is, the user selects any one modification position within the target position range, or selects any one position in a region whose spatial structure complexity is not higher than the first threshold in the target position range), and then the task issuing terminal may render a click state of the position confirmation control into a non-clickable state.

Taking a page shown in FIG. 5 as an example for description, the modification page may include a circular area 51 and a control 52 represented as “Confirm Pick-up Position.” The circular area 51 may include a railway station. If the user selects any position within the railway station in the circular area 51 or any position outside the circular area 51, the task issuing terminal may detect the second input operation, prompt that the starting position cannot be modified, and at the same time, render the click state of the position confirmation control into a non-clickable state.

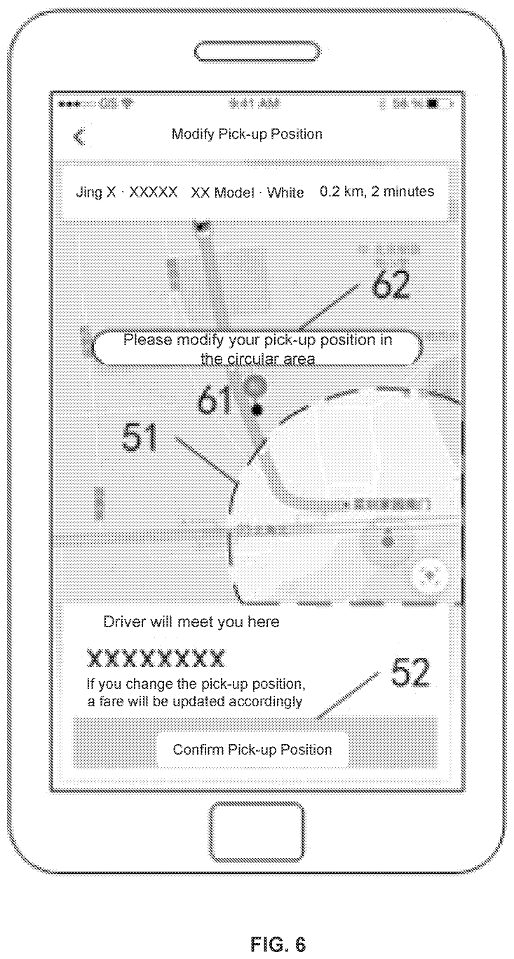

FIG. 6 is a schematic diagram illustrating an exemplary map page according to first embodiments of the present disclosure. As shown in FIG. 6, when the user may select a position 61 as the starting position of the task, and the position 61 is not in the circular area 51, the task issuing terminal may detect the second input operation and determine that the click state of the control 52 represented as “Confirm Pick-up Position” is unclickable. At the same time, the task issuing terminal may prompt “Please modify pick-up position (that is, the starting position) in the circular area” by a bubble 62.

In S209, the position modification information may be received.

In operation S209, the server may receive the position modification information sent by the task issuing terminal.

In S210, the task information of the task may be obtained.

After receiving the position modification information, the server may obtain the task information of the task through the online car-hailing platform.

In S2A, whether a task processing state of the task is unprocessed may be determined.

If the task processing state of the task is unprocessed, the server may perform operation S211 and/or further perform operation S212. If the task processing state of the task is not unprocessed, the server may perform operation S216.

In S211, a position modification prompt and the position modification information may be sent.

In the embodiments, the task processing state of the task may be configured to indicate whether the user has taken a ride. The task processing state of the task may be determined based on the first position information. For example, if a distance between the first position information and the second position information satisfies a distance condition, which indicates that there is a certain distance between the task processing resource and the starting position set by the user, accordingly the server may determine the task processing state of the task as unprocessed. If the distance between the first position information and the second position information does not satisfy the distance condition, which indicates that the task processing resource is close to the starting position set by the user, accordingly the server may determine the task processing state of the task as being processed.

In order to improve the accuracy of the task processing state, the server may determine the task processing state of the task by sending state confirmation information to the task processing terminal and/or the task issuing terminal. If feedback information of the task processing terminal and/or the task issuing terminal indicates that the user has taken the ride, the server may determine the task processing state of the task processing terminal as being processed. If the feedback information of the task processing terminal and/or the task issuing terminal indicates that the user does not take the ride, the server may determine the task processing state of the task processing terminal as unprocessed.

If the task processing state is unprocessed, the server may send the position modification prompt and the position modification information to the task processing terminal to instruct the task processing terminal to modify the starting position of the task based on the third position information.

In S212, the position modification prompt may be sent.

In the embodiments, the server may send the position modification prompt to the task issuing terminal to instruct the task issuing terminal to modify the starting position of the task based on the third position information and inform the user that the starting position has been modified successfully.

It is easy to understand that operation S211 and operation S212 may be performed simultaneously or sequentially, which is not limited in the embodiments.

In S213, the task modification prompt and the position modification information may be received.

After receiving the task modification prompt and the position modification information sent by the server, the task processing terminal may modify the starting position of the task.

In S214, the starting position of the task may be modified based on the third position information.

In possible cases, if a current display page is a navigation page, the task processing terminal may modify the starting position to the third position information through a route navigation interface and update a navigation route based on the third position information. Specifically, the task processing terminal may update the navigation route to a route starting with the first position information and ending with the third position information.

In possible cases, if the current display page is an information display page of the task, the task processing terminal may modify the starting position displayed on the information display page to the third position information through a task information display interface.

In possible cases, if the distance between the first position information and the second position information does not satisfy the distance condition, which indicates that the task processing resource has approached the starting position set by the user, the task processing terminal may switch form a current page to the information display page, modify the starting position displayed on the current display page to the third position information through the task information display interface, and update the task processing status of the task to unprocessed.

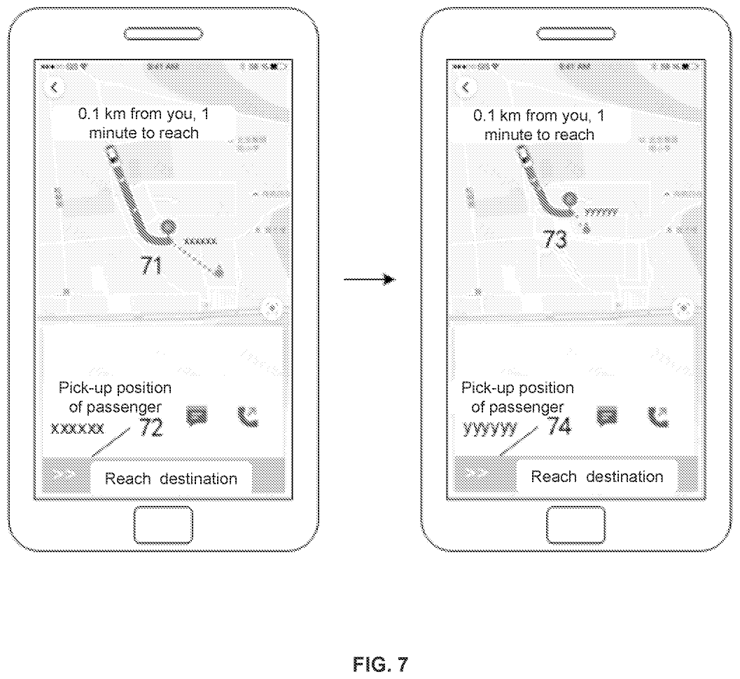

FIG. 7 is a schematic diagram illustrating exemplary map pages according to first embodiments of the present disclosure. Taking a current display page shown in FIG. 7 as a navigation page as an example for description, as shown in FIG. 7, a starting position of the task may be a position 71, that is, “XXXXXX”. First position information of the task processing terminal may indicate that the task processing resource has reached the position 71. Accordingly, the task processing terminal may determine the task processing state of the task as being processed and display the task processing state by controlling the display device to render and display a control 72 represented as “Arrival at Destination.” After receiving the position modification prompt sent by the server, the task processing terminal may modify the starting position of the task to a position 73, that is “YYYYYY” through the route navigation interface, update the navigation route based on the third position information, and update the task processing state by controlling the display device to render and display a control 74 represented as “Arrive at Pick-up Position”.

In S215, the modification of the starting position may be prompted in a form of at least one of voice or bubble.

In the embodiments, the task processing terminal may use a form of at least one of voice or bubble to prompt the modification of the starting position to reduce the possibility that the task processing resource may not notice the change of the starting position during driving and enable the task processing resource to provide the user with a car-hailing service based on the modified starting position.

It is easy to understand that operation S214 and operation S216 may be performed simultaneously or sequentially, which is not limited in the embodiments.

In S216, a rejecting modification prompt may be sent.

In the embodiments, if the task processing state of the task is not unprocessed, for example, being in processing (which indicates that the task processing resource has reached the vicinity of the second position information or the user has taken a ride.) or has been processed (which indicates that the user has reached the destination), the server may send the rejecting modification prompt to the task issuing terminal to inform the user that the modification of the starting position fails.

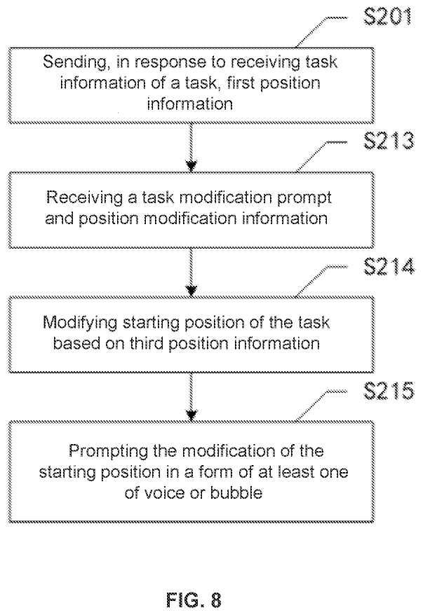

FIG. 8 is a flowchart illustrating an exemplary process for information exchange applied to a task processing terminal in an optional implementation of first embodiments of the present disclosure. As shown in FIG. 8, in the optional implementation of the embodiments, the process for task exchange may include the following operations.

In S201, in response to that task information of a task is received, first position information may be sent.

In S213, a task modification prompt and position modification information may be received.

In S214, starting position of the task may be modified based on third position information.

In S215, the modification of the starting position may be prompted in a form of at least one of voice or bubble.

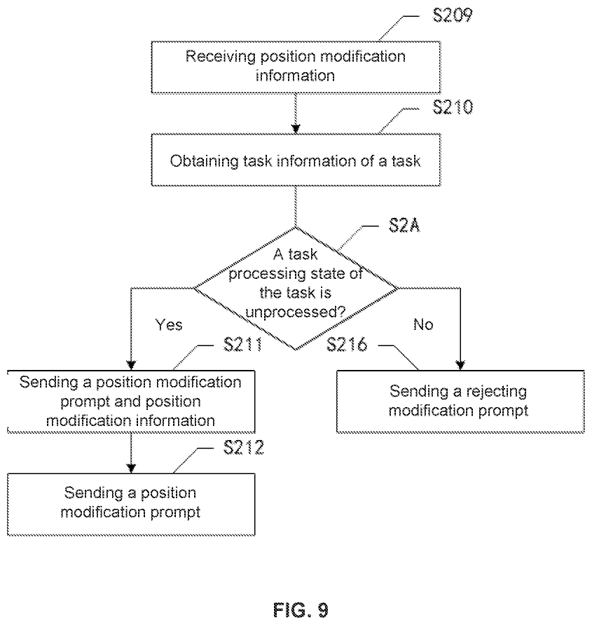

FIG. 9 is a flowchart illustrating an exemplary process for information exchange applied to a server in an optional implementation of first embodiments of the present disclosure. As shown in FIG. 9, in the optional implementation of the embodiments, the process for task exchange may include the following operations.

In S209, position modification information may be received.

In S210, task information of a task may be obtained.

Inn S2A, whether a task processing state of the task is unprocessed may be determined.

If the task processing state of the task is unprocessed, the server may perform operation S211 and/or further perform operation S212. If the task processing state of the task is not unprocessed, the server may perform operation S216.

In S211, position modification prompt and position modification information may be sent.

In S212, the position modification prompt may be sent.

In S216, a rejecting modification prompt may be sent.

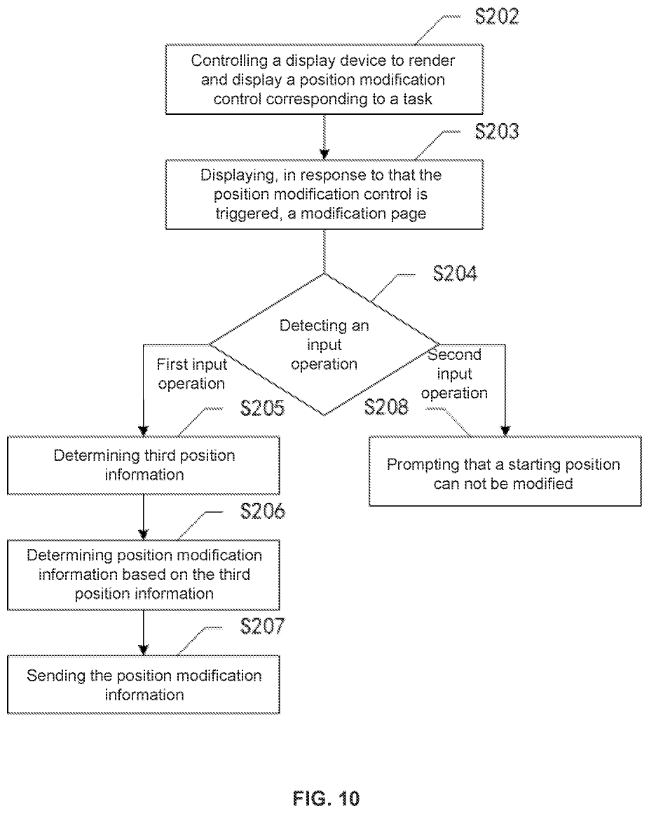

FIG. 10 is a flowchart illustrating an exemplary process for information exchange applied to a task issuing terminal in an optional implementation of first embodiments of the present disclosure. As shown in FIG. 10, in the optional implementation of the embodiments, the process for task exchange may include the following operations.

In S202, the display device may be controlled to render and display a position modification control corresponding to a task.

In S203, in response to that the position modification control is triggered, a modification page may be displayed.

In S204, an input operation may be detected.

If the detected input operation is a first input operation, the task issuing terminal may perform operation S205. If the detected input operation is a second input operation, the task issuing terminal may perform operation S208.

In S205, third position information may be determined.

In S206, position modification information may be determined based on the third position information.

In S207, the position modification information may be sent.

In S208, unable to modify the starting position may be prompted.

In the embodiments, after receiving the task information of the task, the task processing terminal may send the first task information configured to indicate a current position of the task processing terminal. The task issuing terminal may obtain the first position information, control the display device to render and display the position modification control corresponding to the task based on the first position information and the second position information of the task, and display, in response to that the control is triggered, the modification page to detect the input operations. When detecting the first input operation, the task issuing terminal may determine the position information corresponding to the first input operation, and send the position modification information determined based on the position information to the server. When detecting the second input operation, the task issuing terminal may prompt that the starting position cannot be modified. After receiving the position modification information, the server may obtain the task information, and determine the task processing state of the task based on the first position information. When the task processing state is unprocessed, the server may send the position modification prompt and the position modification information to the task processing terminal, so that the task processing terminal may modify the starting position of the task based on the position information. At the same time, the server may send the position modification prompt to the task issuing terminal, so that the task issuing terminal may modify the starting position to the third position information. When the processing state of the task is not unprocessed, the server may send a rejecting modification prompt to the task issuing terminal. In the process of the embodiments, the starting position of the task may be modified after the task is generated, thereby effectively reducing the possibility of the task being canceled, and improving the utilization rate of the task processing resources.

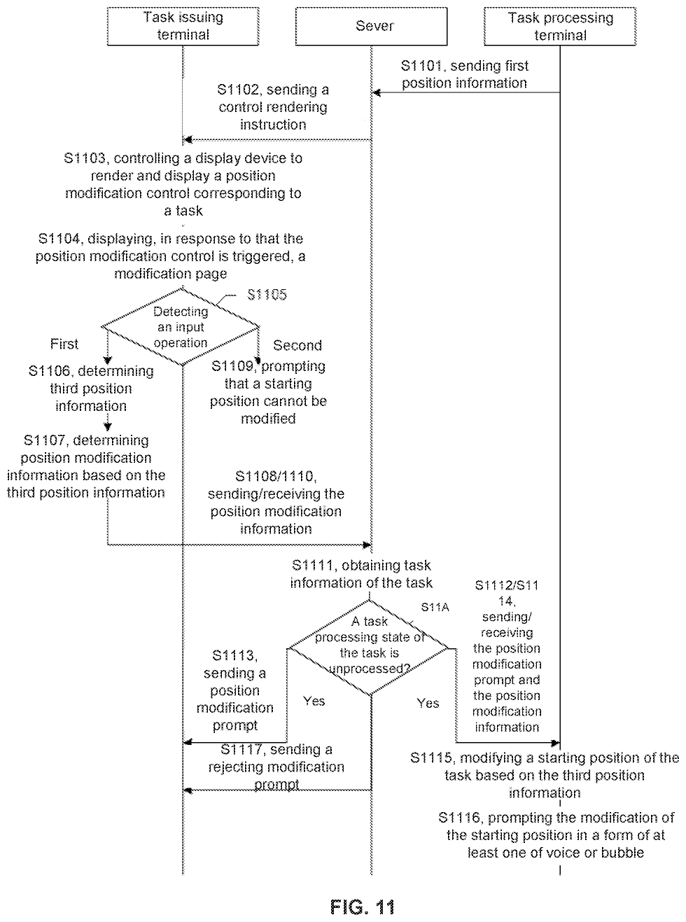

FIG. 11 is a flowchart illustrating an exemplary process for information exchange according to second embodiments of the present disclosure. As shown in FIG. 11, the process of the embodiments may include the following operations.

In S1101, in response to task information of a task is received, first position information may be sent.

In the embodiments, the implementation of operation S1101 may be similar to the implementation of operation S201, and the descriptions thereof are not repeated here.

In S1102, a control rendering instruction may be sent.

In the embodiments, the server may send the control rendering instruction to the task issuing terminal, so that the task issuing terminal may control the display device to render and display a position modification control corresponding to the task, which improves the flexibility of modifying starting position and reduces the possibility of the task being canceled, thereby reducing unnecessary waste of task processing resources.

In operation S1102, the server may obtain the first position information sent by the task processing terminal and send the control rendering instruction based on at least one of the first position information or second position information. Specifically, in response to that a distance between the first position information and the second position information satisfies a distance condition and/or the second position information satisfies a position condition, the server may send the control rendering instruction.

For example, a first position information of a task processing resource is a position L1. A starting position (that is, a second position information) set by the user is L2. If a distance between the position L1 and the position L2 is greater than 1000 m (that is, a distance condition is satisfied), and/or the position L2 is in a range (For example, a range other than an airport, a railway station, etc. with a spatial structure complexity greater than or equal to the first threshold) with a spatial structure complexity less than a first threshold (that is, the second position information satisfies a position condition), the server may send the control rendering instruction to the task issuing terminal.

In S1103, a display device may be controlled to render and display a position modification control corresponding to the task.

In the embodiments, in response to receiving the control rendering instruction, the task issuing terminal may control the display device to render and display the position modification control corresponding to the task based on the second position information.

Additionally or alternatively, the task issuing terminal may render and display the position modification control at a predetermined position on the map page, or render and display the position modification control at a position corresponding to the second position information on the map page, which is not limited in the embodiments. Generally, the second position information is located near a center of the map page, accordingly the predetermined position may be located at an upper left corner, a lower left corner, an upper right corner, a lower right corner, etc. on the map page.

In S1104, in response to that the position modification control is triggered, a modification page may be displayed.

In the embodiments, the implementation of operation S1104 may be similar to the implementation of operation S203, and the descriptions thereof are not repeated here.

In S1105, an input operation may be detected.

After the modification page is displayed, the task issuing terminal may detect the input operation of the user to determine third position information. If the detected input operation is a first input operation, the task issuing terminal may perform operation S1106. If the detected input operation is a second input operation, the task issuing terminal may perform operation S1109.

In S1106, the third position information may be determined.

In the embodiments, the implementation of operation S1106 may be similar to the implementation of operation S205, and the descriptions thereof are not repeated here.

In S1107, the position modification information may be determined based on the third position information.

In the embodiments, the implementation of operation S1107 may be similar to the implementation of operation S206, and the descriptions thereof are not repeated here.

In S1108, position modification information may be sent.

In the embodiments, the implementation of operation S1108 may be similar to the implementation of operation S207, and the descriptions thereof are not repeated here.

In S1109, unable to modify the starting position may be prompted.

In the embodiments, the implementation of operation S1109 may be similar to the implementation of operation S208, and the descriptions thereof are not repeated here.

In S1110, position modification information may be received.

In the embodiments, the implementation of operation S1110 may be similar to the implementation of operation S209, and the descriptions thereof are not repeated here.

In S1111, task information of the task may be obtained.

In the embodiments, the implementation of operation S1111 may be similar to the implementation of operation S210, and the descriptions thereof are not repeated here.

In S11A, whether a task processing state of the task is unprocessed may be determined.

If the task processing state of the task is unprocessed, the server may perform operation S1112 and/or perform operation S1113. If the task processing state of the task is not unprocessed, the server may perform operation S1117.

In S1112, a position modification prompt and position modification information may be sent.

In the embodiments, the implementation of operation S1112 may be similar to the implementation of operation S211, and the descriptions thereof are not repeated here.

In S1113, a position modification prompt may be sent.

In the embodiments, the implementation of operation S1113 may be similar to the implementation of operation S212, and the descriptions thereof are not repeated here.

In S1114, the position modification prompt and the position modification information may be received.

In the embodiments, the implementation of operation S1114 may be similar to the implementation of operation S213, and the descriptions thereof are not repeated here.

In S1115, the starting position of the task may be modified based on the third position information.

In the embodiments, the implementation of operation S1115 may be similar to the implementation of operation S214, and the descriptions thereof are not repeated here.

In S1116, the modification of the starting position may be prompted in a form of at least one of voice or bubble.

In the embodiments, the implementation of operation S1116 may be similar to the implementation of operation S215, and the descriptions thereof are not repeated here.

In S1117, a rejecting modification prompt may be sent.

In the embodiments, the implementation of operation S1117 may be similar to the implementation of operation S216, and the descriptions thereof are not repeated here.

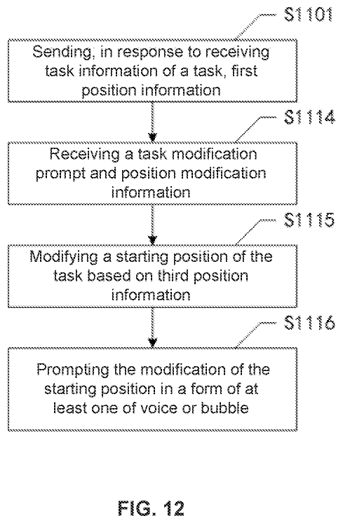

FIG. 12 is a flowchart illustrating an exemplary process for information exchange applied to a task processing terminal in an optional implementation of second embodiments of the present disclosure. As shown in FIG. 12, in the optional implementation of the embodiments, the process for task exchange may include the following operations.

In S1101, in response to that task information of a task is received, first position information may be sent.

In S1114, a task modification prompt and position modification information may be received.

In S1115, a starting position of the task may be modified based on the third position information.

In S1116, the modification of the starting position may be prompted in a form of at least one of voice or bubble.

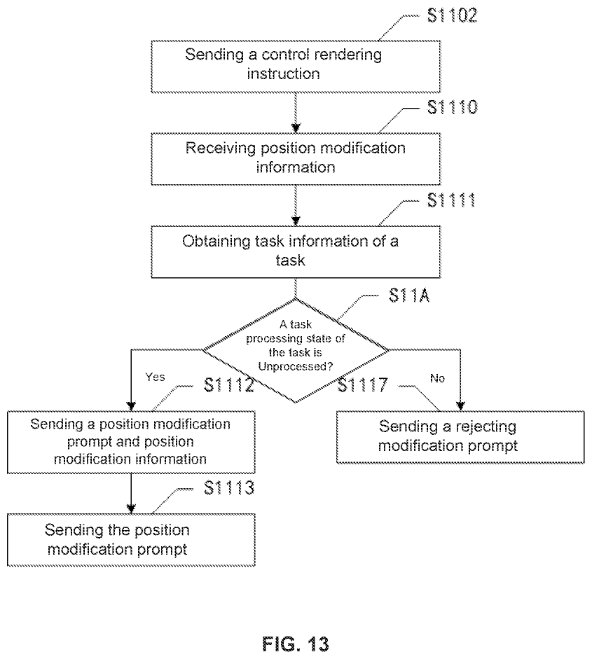

FIG. 13 is a flowchart illustrating an exemplary process for information exchange applied to a server in an optional implementation of second embodiments of the present disclosure. As shown in FIG. 13, in the optional implementation of the embodiments, the process for task exchange may include the following operations.

In S1102, a control rendering instruction may be sent.

In S1110, position modification information may be received.

In S1111, task information of a task may be obtained.

In S11A, whether a task processing state of the task is unprocessed may be determined.

If the task processing state of the task is unprocessed, the server may perform operation S1112 and/or perform operation S1113. If the task processing state of the task is not unprocessed, the server may perform operation S1117.

In S1112, a position modification prompt and position modification information may be sent.

In S1113, the position modification prompt may be sent.

In S1117, a rejecting modification prompt may be sent.

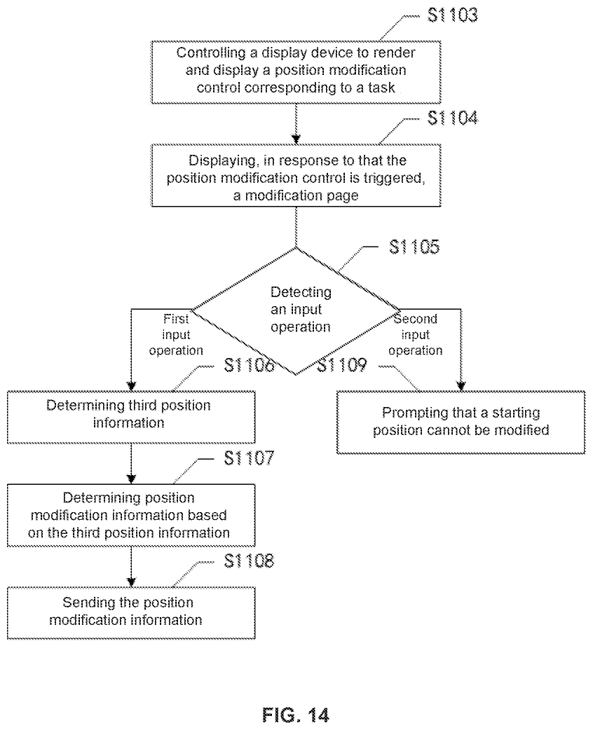

FIG. 14 is a flowchart illustrating an exemplary process for information exchange applied to a task issuing terminal in an optional implementation of second embodiments of the present disclosure. As shown in FIG. 14, in the optional implementation of the embodiments, the process for task exchange may include the following operations.

In S1103, a display device may be controlled to render and display a position modification control corresponding to a task.

In S1104, in response to that the position modification control is triggered, a modification page may be displayed.

In S1105, an input operation may be detected.

If the detected input operation is a first input operation, the task issuing terminal may perform operation S1106. If the detected input operation is a second input operation, the task issuing terminal may perform operation S1109.

In S1106, third position information may be determined.

In S1107, position modification information may be determined based on the third position information.

In S1108, the position modification information may be sent.

In S1109, unable to modify the starting position may be prompted.

In the embodiments, after receiving the task information of the task, the task processing terminal may send the first task information configured to indicate a current position of the task processing terminal. The server may obtain the first position information, and send a control rendering instruction to the task issuing terminal based on the first position information and the second position information of the task. After receiving the control rendering instruction, the task issuing terminal may control the display device to render and display the position modification control corresponding to the task, and display, in response to that the control is triggered, the modification page to detect the input operations. When detecting the first input operation, the task issuing terminal may determine the position information corresponding to the first input operation, and send the position modification information determined based on the position information to the server. When detecting the second input operation, the task issuing terminal may prompt that the starting position cannot be modified. After receiving the position modification information, the server may obtain the task information, and determine the task processing state of the task based on the first position information. When the task processing state is unprocessed, the server may send the position modification prompt and the position modification information to the task processing terminal, so that the task processing terminal may modify the starting position of the task based on the position information. At the same time, the server may send the position modification prompt to the task issuing terminal, so that the task issuing terminal may modify the starting position to the third position information. When the processing state of the task is not unprocessed, the server may send a rejecting modification prompt to the task issuing terminal. In the process of the embodiments, the starting position of the task may be modified after the task is generated, thereby effectively reducing the possibility of the task being canceled, and improving the utilization rate of the task processing resources.

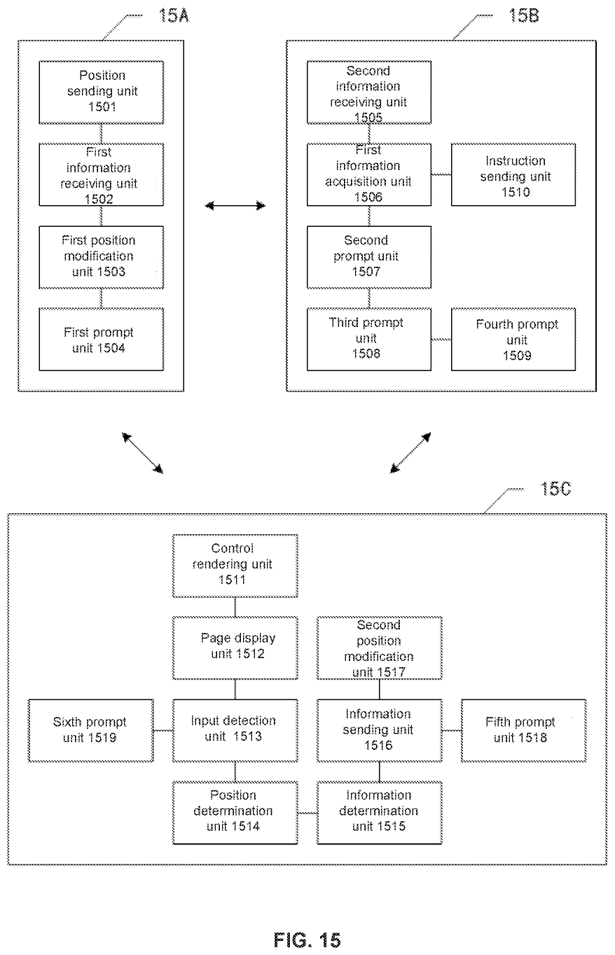

FIG. 15 is a flowchart illustrating an exemplary system for information exchange according to third embodiments of the present disclosure. As shown in FIG. 15, the system of the embodiments may include an information exchange apparatus 15A, an information exchange apparatus 15B, and an information exchange apparatus 15C.

The information exchange apparatus 15A may include a position sending unit 1501, a first information receiving unit 1502, and a first position modification unit 1503.

The position sending unit 1501 may be configured to send, in respond to receiving task information of a task, first position information. The first position information may be configured to indicate a current position of a task processing terminal. The task information may include second position information. The second position information may be configured to indicate starting position of the task. The first information receiving unit 1502 may be configured to receive position modification information. The position modification information may include third position information. The first position modification unit 1503 may be configured to modify start position of the task based on the third position information.

Further, the first position modification unit 1503 may include a first modification subunit.

The first modification subunit may be configured to modify, in response to that a current display page is an information display page, the starting position displayed on the current display page to the third position information through a task information display interface.

Further, the first position modification unit 1503 may include a second modification subunit.

The second modification subunit may be configured to modify, in response to that the current display page is a navigation page, the starting position to the third position information through a route navigation interface and update the navigation route based on the third position information.

Further, the first position modification unit 1503 may include a third modification subunit.

The third modification subunit may be configured to in response to that a distance between the first position information and the second position information does not satisfy a distance condition, switch from the current display page to an information display page, modify the starting position displayed on the current display page to the third position information through a task information display interface, and update a task processing state of the task to unprocessed.

Further, the information exchange apparatus 15A may further include a first prompt unit 1504.

The first prompt unit 1504 may be configured to prompt the modification of the starting position in a form of at least one of voice or bubble.

The information exchange apparatus 15B may include a second information receiving unit 1505, a first information acquisition unit 1506, and a second prompt unit 1507.

The second information receiving unit 1505 may be configured to receive position modification information sent by a task issuing terminal. The position modification information may include the third position information. The first information acquisition unit 1506 may be configured to obtain the task information of the task. The task information may include the second position information. The second position information may be configured to indicate the starting position of the task. The second prompt unit 1507 may be configured to send, in response to that the task processing state of the task is unprocessed, a position modification prompt and the position modification information to a task processing terminal. The position modification prompt may be configured to instruct the task processing terminal to modify the starting position based on the third position information. The task processing state may be determined based on the first position information. The first position information may be configured to indicate the current position of the task processing terminal.

Further, the information exchange apparatus 15B may further include a third prompt unit 1508 and a fourth prompt unit 1509.

The third prompt unit 1508 may be configured to send, in response to that the task processing state is unprocessed, a position modification prompt to the task issuing terminal. The fourth prompt unit 1509 may be configured to send, in response to that the task processing state is not unprocessed, a rejecting modification prompt to the task issuing terminal.

Further, after obtaining the task information of the task, the information exchange apparatus 15B may further include an instruction sending unit 1510.

The instruction sending unit 1510 may be configured to send a control rendering instruction to the task issuing terminal to instruct the task issuing terminal to control the display device to render and display the position modification control corresponding to the task.

Further, the instruction sending unit 1510 may include a first position obtaining subunit and an instruction sending subunit.

The first position obtaining subunit may be configured to obtain the first position information. The first position information may be configured to indicate the current position of the task processing terminal. The instruction sending subunit may be configured to send the control rendering instruction based on at least one of the first position information or the second position information.

Further, the instruction sending subunit may be configured to send, in response to that the distance of the first position information and the second position information satisfies the distance condition and/or the second position information satisfies the position condition, the control rendering instruction.

The information exchange apparatus 15C may include a control rendering unit 1511, a page display unit 1512, an input detection unit 1513, a position determination unit 1514, an information determination unit 1515, and an information sending unit 1516.

The control rendering unit 1511 may be configured to control the display device to render and display the position modification control corresponding to the task. The page display unit 1512 may be configured to display, in response to that the position modification control is triggered, the modification page. The input detection unit 1513 may be configured to detect an input operation. The position determination unit 1514 may be configured to in response to that a first input operation is detected, determine third position information. The third position information may be position information corresponding to the first input operation. The information determination unit 1515 may be configured to determine the position modification information based on the third position information. The information sending unit 1516 may be configured to send the position modification information to the server to modify the starting position.

Further, the control rendering unit 1511 may include a first rendering subunit.

The first rendering subunit may be configured to in response to receiving a control rendering instruction, control the display device to render and display the position modification control corresponding to the task on a map page based on the second position information. The second position information may be the starting position of the task.

Further, the control rendering unit 1511 may include a second position obtaining subunit and a second rendering subunit.

The second position obtaining subunit may be configured to obtain the first position information. The first position information may be configured to indicate the current position of the task issuing terminal. The second rendering subunit may be configured to in response to that the distance between the first position information and the second position information satisfies the distance condition and/or the second position information satisfies the position condition, control the display device to render and display the position modification control corresponding to the task on the map page based on the second position information. The second position information may be the starting position of the task.

Further, the page display unit 1512 may be configured to display, on the modification page, a target position range where the second position information is located and/or at least one recommended modification position within the target position range. The second position information may be the starting position of the task.

Further, the information exchange apparatus 15C may further include a second position modification unit 1517.

The second position modification unit 1517 may be configured to in response to receiving the position modification prompt sent by the server, modify the starting position to the third position information.

Further, the information exchange apparatus 15C may further include a fifth prompt unit 1518.

The fifth prompt unit 1518 may be configured to in response to receiving the prompt for rejecting modification sent by the server, prompt that the starting position cannot be modified in a form of at least one of voice or bubble.

Preferably, the apparatus may further include a sixth prompt unit 1519.

The sixth prompt unit 1519 may be configured to in response to detecting the second input operation, prompt that the starting position cannot be modified.

After receiving the task information of the task, the task processing terminal may send the first position information configured to indicate its own position. At the same time, the task issuing terminal may control the display device to render and display the position modification control corresponding to the task and display, in response to that the control is triggered, the modification page to detect the input operation. When the input operation is detected, the task issuing terminal may determine the position information corresponding to the input operation and send the position modification information determined based on the position information to the server. As a result, the server may obtain the task information and send, in response to that the task processing state of the task is unprocessed, the position modification prompt and position modification information to the task processing terminal, so that the task processing terminal may modify the starting position of the task based on the position information. In the process of the embodiments of the present disclosure, the starting position of the task may be modified after the task is generated, thereby effectively reducing the possibility of the task being cancelled and improving the utilization rate of the task processing resources.

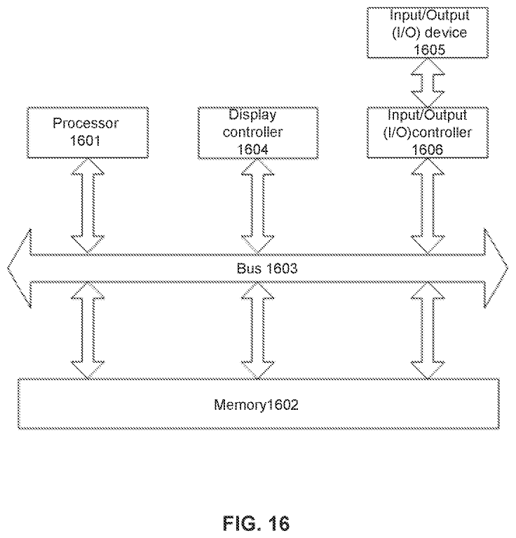

FIG. 16 is a schematic diagram illustrating an exemplary electronic device according to fourth embodiments of the present disclosure. The electronic device shown in FIG. 16 may be a general-purpose data processing apparatus including a general-purpose computer hardware structure. The electronic device at least may include a processor 1601 and a memory 1602. The processor 1601 and the memory 1602 may be connected by a bus 1603. The memory 1602 may be adapted to store instructions or programs executable by processor 1601. The processor 1601 may be an independent microprocessor or a set of one or more microprocessors. The processor 1601 may executes the instructions stored in the memory 1602 to execute the above-described processes in the embodiments of the present disclosure to process data and control other devices. The bus 1603 may connect the above-mentioned various components together to a display controller 1604, a display device, and/or an input/output (I/O) device 1605. The input/output (I/O) device 1605 may be a mouse, a keyboard, a modem, a network interface, a touch input device, a somatosensory input device, a printer, or other devices known in the art. Typically, the input/output (I/O) device 1605 may be connected to the system through input/output (I/O) controllers 1606.

The memory 1602 may store software components, such as operating systems, communication modules, interaction modules, and application programs. Each of the modules and applications described above may correspond to a set of executable program instructions that perform one or more functions and processes described in embodiments of the present disclosure.

The foregoing flowchart and/or block diagrams of methods, apparatus (systems) and computer program products based on embodiments of the present disclosure describe various aspects of the present disclosure. It may be understood that each block of the flowchart illustrations and/or block diagrams, and combinations of blocks in the flowchart illustrations and/or block diagrams, may be implemented by computer program instructions. These computer program instructions may be provided to a processor of general-purpose computer, special purpose computer, or other programmable data processing device to produce a machine such that the instructions (executed via the processor of a computer or other programmable data processing device) create functions/acts for implementing the functions/acts specified in the flowchart and/or block diagram blocks or blocks device.

Meanwhile, as will be appreciated by those skilled in the art, various aspects of the embodiments of the present disclosure may be implemented as a system, method, or computer program product. Accordingly, various aspects of embodiments of the invention may take the form (including firmware, resident software, microcode, etc.) of an entirely hardware implementation, an entirely software implementation, or a combination of software and hardware aspects that may all be generally referred to herein as “circuits,” “modules,” or “systems.” combined implementation. Furthermore, aspects of the present disclosure may take the form of a computer program product embodied in one or more computer readable media having computer readable program code embodied thereon.

Any combination of one or more computer-readable media may be utilized. The computer-readable medium may be a computer-readable signal medium or a computer-readable storage medium. The computer-readable storage medium may be, for example, but not limited to, an electronic, magnetic, optical, electromagnetic, infrared, or semiconductor system, device, or apparatus, or any suitable combination of the foregoing. More specific examples (non-exhaustive list) of computer readable storage media would include the following: electrical connections with one or more wires, portable computer floppy disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the foregoing. In the context of embodiments of the present disclosure, a computer-readable storage medium may be any tangible medium that may contain or store a program for use by or in connection with an instruction execution system, device, or apparatus

A computer-readable signal medium may include a propagated data signal having computer-readable program code embodied therein, such as in baseband or as part of a carrier wave. Such propagated signals may take any of a variety of forms including, but not limited to, electromagnetic, optical, or any suitable combination thereof. The computer-readable signal medium can be any of the following computer-readable medium: not a computer-readable storage medium and may communicate, propagate, or transmit programs for use by or in connection with the instruction execution system, device, or apparatus.

Computer program code for carrying out operations for various aspects of the present disclosure may be written in any combination of one or more programming languages, including object-oriented programming languages such as Java, Smalltalk, C++, PHP, Python, etc.; and conventional procedural programming languages such as the “C” programming language or similar programming languages. The program code may execute entirely on the user's computer, partly on the user's computer, as a stand-alone software package; partly on the user's computer and partly on a remote computer; or entirely on the remote computer or server. In the latter case, the remote computer may be connected to the user's computer through any type of network including a local area network (LAN) or wide area network (WAN), or may be connected to an external computer (e.g., by using an Internet service provider's Internet).

The above is only a preferred embodiment of the present disclosure, and is not intended to limit the present disclosure. For those skilled in the art, the present disclosure may have various changes and changes. Any modification, equivalent replacement, improvement, etc. made within the spirit and principle of the present disclosure shall be included within the protection scope of the present disclosure.

1. A method for information exchange, applied to a task processing terminal, comprising:
sending, in response to receiving task information of a task, first position information, the first position information being configured to indicate a current position of the task processing terminal, the task information including second position information, the second position information being configured to indicate a starting position of the task;
receiving a position modification prompt and position modification information, the position modification information including third position information; and
modifying the starting position of the task based on the third position information.

2. The method of claim 1, wherein the modifying the starting position of the task based on the third position information comprises:
modifying, in response to that a current display page is an information display page, the starting position displayed on the current display page to the third position information through a task information display interface.

3. The method of claim 1, wherein the modifying the starting position of the task based on the third position information comprises:
modifying, in response to that a current display page is a navigation page, the starting position to the third position information through a route navigation interface.

4. The method of claim 1, wherein the modifying the starting position of the task based on the third position information comprises:
in response to that a distance between the first position information and the second position information does not satisfy a distance condition,
switching from a current display page to an information display page;
modifying the starting position displayed on the current display page to the third position information through a task information display interface; and
updating a task processing state of the task to unprocessed.

5. The method of claim 1, further comprising:
prompting the modification of the starting position in a form of at least one of voice or bubble.

6. A method for information exchange, applied to a server, comprising:
receiving position modification information sent by a task issuing terminal, the position modification information including third position information;
obtaining task information of a task, the task information including second position information, the second position information being configured to indicate a starting position of the task; and
sending, in response to that a task processing state of the task is unprocessed, a position modification prompt and the position modification information to a task processing terminal, the position modification prompt being configured to instruct the task processing terminal to modify the starting position based on the third position information, the task processing state being determined based on first position information, the first position information being configured to indicate a current position of the task processing terminal.

7. The method of claim 6, further comprising:
sending, in response to that the task processing state is unprocessed, the position modification prompt to the task issuing terminal; and
sending, in response to that the task processing state is not unprocessed, a rejecting modification prompt to the task issuing terminal.

8. The method of claim 6, wherein after obtaining the task information of the task, the method further comprises:
sending a control rendering instruction to the task issuing terminal to instruct the task issuing terminal to control a display device to render and display a position modification control corresponding to the task.

9. The method of claim 8, wherein the sending the control rendering instruction to the task issuing terminal comprises:
obtaining the first position information; and
sending the control rendering instruction based on at least one of the first position information or the second position information.

10. The method of claim 9, wherein the sending the control rendering instruction based on at least one of the first position information or the second position information comprises:
in response to that a distance between the first position information and the second position information satisfies a distance condition or the second position information satisfies a position condition, sending the control rendering instruction.

11. A method for information exchange, applied to a task issuing terminal, comprising:
controlling a display device to render and display a position modification control corresponding to a task;
in response to that the position modification control is triggered, displaying a modification page;
detecting an input operation;
in response to that a first input operation is detected, determining third position information; the third position information being position information corresponding to the first input operation;
determining position modification information based on the third position information; and
sending the position modification information to a server to modify a starting position of the task.

12. The method of claim 11, wherein the controlling the display device to render and display the position modification control corresponding to the task comprises:
controlling, in response to receiving a control rendering instruction, the display device to render and display the position modification control corresponding to the task on a map page based on the second position information, the second position information being the starting position of the task.

13. The method of claim 12, wherein the controlling the display device to render and display the position modification control corresponding to the task on the map page comprises:
obtaining first position information, the first position information being configured to indicate a current position of the task issuing terminal;
in response to that a distance between the first position information and the second position information satisfies a distance condition or the second position information satisfies a position condition, controlling the display device to render and display the position modification control corresponding to the task on the map page based on the second position information, the second position information being the starting position of the task.

14. The method of claim 11, wherein the displaying the modification page comprises:
displaying, on the modification page, a target position range where the second position information is located or at least one recommended modification position within the target position range, the second position information being the starting position of the task; or
controlling the display device to render the display a position confirmation control in the modification page.

15. The method of claim 11, further comprising:
in response to receiving the position modification prompt sent by the server, modifying the starting position to the third position information.

16. The method of claim 11, further comprising:
in response to receiving a rejecting modification prompt sent by the server, prompting that the starting position cannot be modified in a form of at least one of voice or bubble.

17. The method of claim 11, further comprising:
in response to that a second input operation is detected, prompting that the starting position cannot be modified.

18-38. (canceled)

39. The method of claim 3, further comprising:
updating a navigation route based on the third position information.
